(19) United States
(12) Patent Application Publication
(10) Pub. No.: US 2023/0219587 A1
(43) Pub. Date: Jul. 13, 2023

(54) Driver Assistance in Low Speed Range

(71) Applicant: Bayerische Motoren Werke Aktiengesellschaft, Muenchen (DE)

(72) Inventors: Thomas HELMER, Muenchen (DE); Peter SCHNEIDER, Haar (DE)

(21) Appl. No.: 18/008,825

(22) PCT Filed: May 25, 2021
(86) PCT No.: PCT/EP2021/063886

§ 371 Date: Dec. 7, 2022

(30) Foreign Application Priority Data
Jun. 9, 2020 (DE) 10 2020 115 309.0

(51) Int. Cl. B60W 50/08; B60W 30/18; B60W 40/04; B60W 10/18

(52) U.S. Cl. CPC B60W 50/087; B60W 30/18018; B60W 40/04; B60W 10/18; B60W 2540/10; B60W 2520/10; B60W 2554/802; B60W 2754/30

(57) ABSTRACT

A method provides driver assistance in a motor vehicle in particularly dense and confusing traffic conditions in the low-speed range. It is possible to adjust the distance in dense traffic so that it is not too great whilst at the same time ensuring that the driver does not always have to vary the position of the accelerator pedal. The accelerator is controlled in accordance with the distance and thus the speed or accelerator is automatically throttled as the distance decreases.

### BACKGROUND AND SUMMARY

The invention relates to a method, system, and computer product for providing driver assistance in a motor vehicle in particularly dense and complex traffic conditions in the low speed range.

EP 2 176 109 B1 discloses a device having a distance-measuring ultrasound sensor and a control unit, which is configured to intervene in the longitudinal guiding of the host vehicle in dependence on the distance, measured by the remote region sensor, from a vehicle traveling in front.

EP 2 481 650 B1 discloses a method for operating a longitudinal driver assist system of a motor vehicle, in particular an ACC system, characterized in that environmental data of the motor vehicle is evaluated with respect to travel in a longitudinal convoy having at least three motor vehicles, which include the motor vehicle and at least two additional motor vehicles, that are driving immediately behind one another and each have an active longitudinal driver assist system.

EP 1 485 268 B1 discloses a cruise control system for motor vehicles, having a sensor device for measuring operating parameters of the vehicle and for measuring the distance to an object located in front of the vehicle, and having a controller for controlling the vehicle's speed or acceleration in dependence on the measured operating parameters and distance data, wherein the controller has a stop & go function for automatically controlling driving off, rolling and stopping in dependence on the movements of the object.

Conventional adaptive cruise control (ACC) systems and emergency braking and forward collision warning systems are known. The latter intervene very late and hard where there is an acute risk of a forward collision, while the former maintain at least the legal minimum distance, or more distance than the average drivers, especially in Asian countries.

Driver assistance is often optimized for Central European or North American traffic conditions. A typical behavior of the longitudinal control is that the host vehicle is not set in motion until the distance to the vehicle in front is relatively large, maintains an ample safety distance, and stops at a large distance behind the vehicle in front. In regions with very dense or seemingly chaotic traffic conditions, such as in some countries, such a large distance to the vehicle in front is often interpreted as an invitation to cut in by other road users. This means that the host vehicle constantly falls back, that is to say is pushed back in the line.

Driving in complex or seemingly chaotic traffic conditions is very demanding and requires a high degree of concentration. Specifically in such conditions, support from the driver assistance system is desirable. The current functions are in most cases not used for the reasons mentioned above. In particular, very specific demands are made of a driver assistance system in such dense traffic, and these demands are not comparable with scenarios that are already handled.

An object of the present invention is to propose an improved, in particular more reliable, method for driver assistance in a motor vehicle in particularly dense and complex traffic conditions in the low speed range, preferably of a motor car or motorcycle. A further object of the present invention is to provide a correspondingly adapted system arrangement and a computer program product with control commands which implement the method or at least partially operate the proposed system arrangement.

Accordingly, there is proposed a method for providing driver assistance in a motor vehicle in particularly dense and complex traffic conditions in the low speed range, comprising manually overriding an already activated driver assistance method, wherein the activated driver assistance method is adapted for setting the distance to a motor vehicle in front, by exertion of pressure on an accelerator pedal; controlling the fuel intake proportionally to the decreasing distance to the motor vehicle in front; and stopping the fuel intake when a predefined minimum distance is reached.

According to the invention, it is possible to adjust the distance in dense traffic so that it does not become too great and yet the driver does not constantly have to vary the position of the accelerator pedal. The fuel intake is controlled in dependence on the distance, and thus the speed or the fuel intake is throttled in an automated manner as the distance decreases.

According to the invention, driver assistance is provided in a low speed range. This range can be approximately below 30 km/h. In conventional driver assistance systems, it is always ensured that a mode of driving that is as fluid and dynamic as possible is achieved. This is not provided according to the invention because, in dense urban traffic, there are frequent speed variations. The proposed method also takes account of this and varies the speed accordingly.

The invention also overcomes the disadvantage that a driver, on accelerating, always experiences the same acceleration when he depresses the accelerator pedal. This does not take account of different scenarios, however, and thus, in dense urban traffic, the effect of the accelerator pedal is also to be adapted.

According to the invention, manual overriding of an already active driver assistance method is provided. A driver assistance system that is already active in the motor vehicle that is carrying out the method according to the invention is, for example, a conventional driver assistance system, such as, for example, a cruise control system. Such a cruise control system is designed to follow a vehicle in front and maintain a corresponding distance therefrom over long distances. A large safety distance is thereby maintained, which is often unrealistic in urban traffic. Moreover, excessively large gaps develop with conventional driver assistance systems, which is to be avoided according to the invention. The overriding of the active driver assistance system serves this purpose.

Overriding is carried out in such a manner that the driver operates the accelerator pedal in the low speed range, and thus the speed is no longer controlled by the driver assistance system which is already activated, but is initially increased manually. This can take place if the distance to a vehicle in front becomes so large that another road user could cut in. Thus, acceleration takes place and a gap that is too large is immediately made smaller so that another road user cannot cut in.

Thus, one aspect according to the invention is that overriding initially takes place because it is necessary specifically in the described scenario. According to conventional methods, a driver assistance system has to be activated manually, and it has been recognized according to the invention that this can take place by overriding. Thus, a change is made in the low speed range from an active driver assistance system according to one aspect of the invention into the driver assistance system according to the invention. The invention thus has the advantage that a specialized driver assistance system is created, which refines or expands existing driver assistance systems in the described situation.

Controlling the fuel intake proportionally to the decreasing distance to the motor vehicle in front takes account of the fact that, by means of the manual overriding or acceleration, the distance to the vehicle in front reduces. If this distance to the vehicle in front reduces, then the fuel intake likewise reduces. This means that, with the same position of the accelerator pedal, the acceleration is relatively lower. Thus, it is possible for the driver to keep the accelerator pedal depressed without moving closer to the vehicle in front. Assistance is thus provided to the driver in that he does not constantly have to accelerate and release the accelerator pedal again but can instead remain on the accelerator pedal and the driver assistance system controls the speed automatically. If, for example, the driver or his vehicle is still at a distance of 3 m from the vehicle in front, overriding, that is to say acceleration, can take place and the distance decreases. Because the vehicle should thereby not accelerate excessively by means of the operation of the accelerator pedal, the fuel intake is reduced as the distance decreases, and the distance is thus effectively decreased such that the host vehicle does not move closer to the vehicle in front, nor is another road user given the opportunity to cut in.

This overcomes the disadvantage in the prior art that, even in the case of manual overriding of the driver assistance system, a forward collision would take place in that the vehicle is constantly accelerated further or is accelerated such that it can no longer be braked in good time. According to the invention, the fuel intake is reduced and thus the forward collision is avoided.

If a predefined minimum distance, for example one meter, is reached, the fuel intake is stopped completely, even if the driver continues to keep the accelerator pedal pressed. It is thus ensured that the minimum distance is maintained but, in addition, a situation does not occur in which the motor vehicle could no longer maintain even a designated minimum distance. Because a minimum distance of, for example, one meter is set low, the fuel intake is then stopped, so that a collision is avoided. In such a state, overriding of the driver assistance system according to the invention is also not possible, because a forward collision could consequently occur.

One aspect of the invention is a system which guides the host vehicle along behind the vehicle in front as if it were on a short, strong rubber band. Thus, a large gap cannot develop and a vehicle cannot cut in. At the same time, driving safety is ensured because a forward collision cannot occur.

In contrast to the known adaptive cruise control ACC, which is designed for convenience and safety, in this system according to one aspect of the present invention manual overriding effects control in respect of the vehicle in front directly (e.g. about one meter after restart) and at smaller distances (gap grows by max. 10 cm). Another difference is that the driver is here more closely involved via operation of the accelerator pedal. An extremely tight and reactive system can thus be produced, which is a different aim for the driver than in a known ACC.

Cameras, radar, lidar can be used as the sensor system. It must also be possible to robustly measure very small distances (about 20 cm). Precise sensors can be used. The invention relates likewise to the control and functional design and to the hardware requirements.

A normal, preceding operating state can be a known ACC system. A new operating state according to one aspect of the present invention can subsequently be activated, for example limited to the low speed range, e.g. below 30 km/h. Driving at a very small distance with manual overriding by means of the accelerator pedal can take place. In comparison to a known ACC system, the following changes are possible. As soon as the driver overrides the ACC system by means of the accelerator pedal, the vehicle moves ever closer to the vehicle in front. According to one aspect of the present invention, control of the fuel intake proportionally to the decreasing distance is thereby used. Thus, this has the effect that there is no risk of collision, despite manual overriding, and the driver intuitively feels the decreasing distance in the accelerator pedal response.

Moreover, according to one aspect of the present invention, the small distance is shown on a display, e.g. by means of a camera image and/or evaluation.

According to one aspect of the present invention, the method is activated automatically when the speed of the motor vehicle falls below a predefined speed. This has the advantage that the driver receives assistance without being distracted during activation. He can choose a speed himself or the speed is predetermined. There is thus a seamless transition from one assistance system to the next.

According to a further aspect of the present invention, the method is activated manually or automatically when the speed of the motor vehicle falls below 30 km/h. This has the advantage that the low speed range is defined as below or equal to 30 km/h, and precisely those scenarios in which the driver receives most assistance in dense traffic situations are thus covered. According to the invention, it has been recognized that this speed or this low speed range requires the most support and the proposed method provides the most benefit.

According to a further aspect of the present invention, the proportional control is carried out in accordance with an empirically determined profile. This has the advantage that it can be determined in advance how the control best functions and thus the driver in the field is offered the best solution. Thus, different driving parameters can be tested out and different conditions can be taken into consideration.

According to a further aspect of the present invention, stopping the fuel intake comprises braking. This has the advantage that the minimum distance is always maintained. This causes more abrupt driving than the driver is accustomed to in accordance with conventional assistance systems, but this is necessary in the scenario of dense and complex traffic described at the beginning.

According to a further aspect of the present invention, the predefined minimum distance is one meter. This has the advantage that the distance that is set is precisely the distance that prevents a forward collision, is controllable in the low speed range and, moreover, prevents other road users from cutting in. One meter has been recognized according to the invention as being a suitable value which ensures safety and yet effectively prevents the host vehicle from falling back in flowing traffic.

According to a further aspect of the present invention, a tolerance range of 10 cm with respect to the minimum distance is provided. This has the advantage that, when moving closer or braking, a small tolerance range is provided, which on the one hand brings with it an abrupt style of driving but on the other hand can be maintained by current motor vehicles.

According to a further aspect of the present invention, a front camera with image transfer to the driver is activated in a preliminary method step. This has the advantage that the distance to a vehicle in front can be estimated precisely in the low speed range. The driver is thereby additionally supported and is given a further perspective on the situation. The image can be presented to the driver on a screen or in the windscreen.

According to a further aspect of the present invention, the minimum distance and the maximum distance are preset in a plurality of configurations, and the driver can select a configuration. This has the advantage that configurations can be stored by the manufacturer, which are then presented to the driver for selection. Consequently, he is able to set which configuration is the most suitable in the current traffic situation.

According to one aspect of the present invention, distances are measured by means of at least one imaging sensor, at least one camera, at least one radar sensor, at least one ultrasonic sensor and/or at least one distance sensor. This has the advantage that the environmental model can be prepared by means of sensors which in some cases are already installed in motor vehicles. In particular, any combination of sensors can be used, so that a reliable environmental model can be prepared. In particular, a sensor can be selected according to the prevailing situation. If there is fog, an optical sensor is to be dispensed with and radar, for example, can be used.

The object is also achieved by a system arrangement for providing driver assistance in a motor vehicle in particularly dense and complex traffic conditions in the low speed range, comprising an activation unit adapted for manually overriding an already activated driver assistance method, wherein the activated driver assistance method is adapted for setting the distance to a motor vehicle in front, by exertion of pressure on an accelerator pedal; a control unit adapted for proportionally controlling the fuel intake in relation to the decreasing distance to the motor vehicle in front; and a distance unit adapted for stopping the fuel intake when a predefined minimum distance is reached.

The object is also achieved by a computer program product with control commands which carry out the method and operate the proposed arrangement when they are executed on a computer.

According to the invention, it is particularly advantageous that the method can be used for operating the proposed apparatuses and units or the system arrangement. Furthermore, the proposed apparatuses and devices are suitable for carrying out the method according to the invention. Thus, the apparatus in each case implements structural features which are suitable for carrying out the corresponding method. The structural features can, however, also be configured as method steps. The proposed method also provides steps for implementing the function of the structural features.

Further advantages, features and details of the invention will become apparent from the following description, in which aspects of the invention are described in detail with reference to the drawings. The features mentioned in the claims and in the description can each be essential to the invention individually on their own or in any desired combination. Likewise, the features mentioned above and the features set out hereinbelow can each be used on their own or in a plurality in any desired combinations. The embodiments shown and described are not to be interpreted as being conclusive but are of an exemplary nature for explaining the invention. The detailed description serves to inform the skilled person, and for this reason known set-ups, structures and methods are not shown or explained in detail in the description so as not to impede the understanding of the present description.

### BRIEF DESCRIPTION OF THE DRAWING

FIG. 1 is a schematic flow diagram of a method for providing driver assistance in a motor vehicle in particularly dense and complex traffic conditions in the low speed range according to one aspect of the present invention.

### DETAILED DESCRIPTION OF THE DRAWING

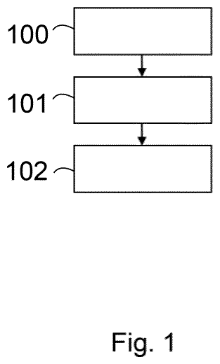

FIG. 1 shows, in a schematic flow diagram, a method for providing driver assistance in a motor vehicle in particularly dense and complex traffic conditions in the low speed range, comprising manually overriding 100 an already activated driver assistance method, wherein the activated driver assistance method is adapted for setting the distance to a motor vehicle in front, by exertion of pressure on an accelerator pedal; controlling 101 the fuel intake proportionally to the decreasing distance to the motor vehicle in front; and stopping 102 the fuel intake when a predefined minimum distance is reached.

The skilled person will hereby recognize that the steps can comprise further sub-steps, and in particular that the method steps can in each case be carried out iteratively and/or in a different order.

The method can provide further sub-steps, such as monitoring of the distance and braking.

In an alternative interpretation, the individual blocks of the method diagram can be understood as being structural units which provide the functionality of the corresponding method steps.

1.-10. (canceled)

11. A method for providing driver assistance in a motor vehicle operating in dense and complex traffic conditions in a low speed range, comprising:
receiving a manual override of an already activated driver assistance system, wherein the activated driver assistance system is adapted for setting a distance to a motor vehicle in front, by exertion of pressure on an accelerator pedal;
controlling fuel intake proportionally to a decreasing distance to the motor vehicle in front; and
stopping the fuel intake when a predefined minimum distance is reached.

12. The method according to claim 11, wherein the method is activated automatically when the speed of the motor vehicle falls below a predefined speed.

13. The method according to claim 11, wherein the method is activated manually or automatically when the speed of the motor vehicle falls below 30 km/h.

14. The method according to claim 11, wherein proportional control of the fuel intake is carried out in accordance with an empirically determined profile.

15. The method according to claim 11, wherein the stopping of the fuel intake comprises braking.

16. The method according to claim 11, wherein the predefined minimum distance is one meter.

17. The method according to claim 16, wherein a tolerance range of 10 cm is provided for the predefined minimum distance.

18. The method according to claim 11, wherein a front camera with image transfer to a driver is activated in a preliminary method step.

19. A system arrangement for providing driver assistance in a motor vehicle operating in dense and complex traffic conditions in a low speed range, comprising:
an activation unit adapted to receive a manual override of an already activated driver assistance system, wherein the activated driver assistance system is adapted for setting a distance to a motor vehicle in front, by exertion of pressure on an accelerator pedal;
a control unit adapted for proportionally controlling fuel intake in relation to a decreasing distance to the motor vehicle in front; and
a distance unit adapted for stopping the fuel intake when a predefined minimum distance is reached.

20. A computer product comprising a computer-readable medium having stored thereon program code that, when executed, carries out the acts of:
receiving a manual override of an already activated driver assistance system, wherein the activated driver assistance system is adapted for setting a distance to a motor vehicle in front, by exertion of pressure on an accelerator pedal;
controlling fuel intake proportionally to a decreasing distance to the motor vehicle in front; and
stopping the fuel intake when a predefined minimum distance is reached with control commands which carry out the method.
